(19) United States
(12) Patent Application Publication
(10) Pub. No.: US 2019/0180298 A1
(43) Pub. Date: Jun. 13, 2019

(54) SYSTEM AND METHOD FOR PROVIDING SHOPPING INFORMATION

(71) Applicant: GENIEWORKS, INC., Seoul (KR)

(72) Inventor: Ang Lee, Seoul (KR)

(73) Assignee: GENIEWORKS, INC., Seoul (KR)

(21) Appl. No.: 15/839,444

(22) Filed: Dec. 12, 2017

(51) Int. Cl. G06Q 30/02; G06Q 50/00

(52) U.S. Cl. CPC G06Q 30/0203; G06Q 30/0209; G06Q 50/01; G06Q 30/0218

(57) ABSTRACT

A system and method for providing shopping information are provided. The system includes a survey product selector for selecting a product selected by a product registrant as a survey product, a preference score collector for collecting preference scores for the survey product from a plurality of survey participants among users, a winner selector for calculating the average of the preference scores, and selecting at least one survey winner from among the plurality of survey participants based on the average, and a winner reward decider for determining a reward to be offered to the at least one survey winner.

### BACKGROUND OF THE INVENTION

### Field of the Invention

The present disclosure relates to a system and method for providing shopping information, and more particularly to a system and method for collecting preference scores, and giving a reward to a user which has entered a preference score closest to an average preference score.

### Discussion of the Related Art

As smartphone applications are available in an application store, various services have recently been provided through smartphone applications.

Meanwhile, general online advertisements of products from online shopping sites, such as banner ads and pop-up ads may bother customers, and are not effective due to low click rates. Considering that these general Internet advertisements are ineffective and expensive, there is a need for an alternative advertisement technique that is effective in advertisement and cost.

### SUMMARY OF THE INVENTION

Accordingly, the present disclosure is directed to a system and method for providing shopping information that substantially obviates one or more problems due to limitations and disadvantages of the related art.

An aspect of the present disclosure is to provide a style chance-based shopping information providing system for providing a meaningful evaluation of users to a product registrant by creating a survey for collecting preference scores for a product.

Another aspect of the present disclosure is to provide a shopping information providing system for motivating users to enter preferences by offering a reward to a survey winner which has entered a preference score closest to an average preference score for a product.

Another aspect of the present disclosure is to provide a shopping information providing system for providing information about a survey product on a social networking service (SNS) page of a survey winner.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a system for providing shopping information includes a survey product selector for selecting a product selected by a product registrant as a survey product, a preference score collector for collecting preference scores for the survey product from a plurality of survey participants among users, a winner selector for calculating the average of the preference scores, and selecting at least one survey winner from among the plurality of survey participants based on the average, and a winner reward decider for determining a reward to be offered to the at least one survey winner.

In the present disclosure, the winner selector may determine rankings of the plurality of survey participants in an order of closeness of entered preference scores to the average.

In the present disclosure, the preference score collector may collect preference scores from users having cyber points, and cyber points corresponding to a predetermined money amount may be paid to each of the plurality of users during a predetermined time period.

In the present disclosure, the reward decider may determine a free coupon for free offer of the survey product as the reward.

In the present disclosure, the system may further includes an SNS manager for providing an SNS account to each of the users, and the SNS manager may display information about the survey product on an SNS page of a user selected as the survey winner.

In the present disclosure, upon occurrence of a purchase of the survey product through a link corresponding to the information about the survey product displayed on the SNS page, the reward decider may determine to allocate a part of a purchase profit to the survey winner.

According to an aspect of the present disclosure, a method for providing shopping information includes a survey product selection step for selecting a product selected by a product registrant as a survey product, a preference score collection step for collecting preference scores for the survey product from a plurality of survey participants among users, a winner selection step for calculating the average of the preference scores, and selecting at least one survey winner from among the plurality of survey participants based on the average, and a winner reward determination step for determining a reward to be offered to the at least one survey winner.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a schematic view illustrating a game chance-based product advertisement system according to an embodiment of the present disclosure;

FIG. 2 is a block diagram illustrating an internal structure of a service server according to an embodiment of the present disclosure;

FIG. 3 is an exemplary view illustrating a user terminal which displays a game chance table generated according to an embodiment of the present disclosure;

FIG. 4 is an exemplary view illustrating a user terminal which displays a game waiting room according to an embodiment of the present disclosure;

FIG. 5 is an exemplary view illustrating a user terminal which displays the results of a game according to an embodiment of the present disclosure;

FIG. 6 is an exemplary view illustrating a user terminal which displays a screen for collecting preference scores according to an embodiment of the present disclosure;

FIG. 7 is an exemplary view illustrating a user terminal which displays the results of a survey according to an embodiment of the present disclosure; and

FIG. 8 is an exemplary view illustrating a social networking service (SNS) page of a user according to an embodiment of the present disclosure.

### DETAILED DESCRIPTION OF THE INVENTION

The following description is given of specific embodiments of the present disclosure with reference to the attached drawings.

The following embodiments are to be construed in all aspects as illustrative and not restrictive. The scope of the present disclosure should be determined by the appended claims and their legal equivalents, not by the following description, and all changes coming within the meaning and equivalency range of the appended claims are intended to be embraced therein. Like reference numerals denote the same or similar components in many aspects in the drawings.

With reference to the accompanying drawings, various embodiments of the present disclosure will be described below in detail so that those skilled in the art may readily implement the present disclosure.

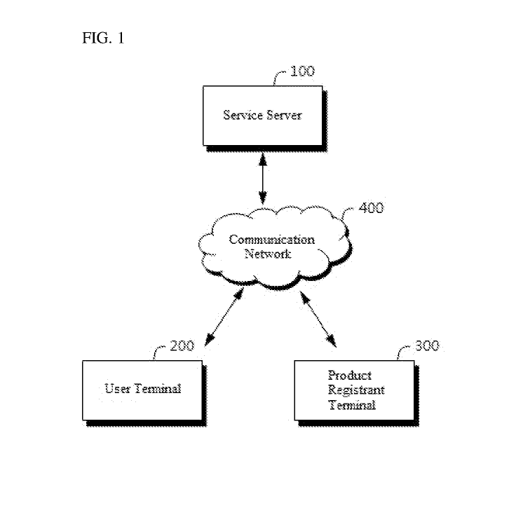

FIG. 1 is a schematic view illustrating a game chance-based product advertisement system according to an embodiment of the present disclosure.

Referring to FIG. 1, the game chance-based product advertisement system according to the embodiment of the present disclosure may include a service server 100, a user terminal 200, and a product registrant terminal 300.

The service server 100 illustrated in FIG. 1 receives product information from a product registrant, determines game chance information based on the product information, sets users as subscribers to a game chance by receiving subscription requests for the game chance from the users, provides a game to the game subscribers at the starting time of a game, and determines a reward recipient and a reward type based on user rankings in the game.

Recently, many techniques have been used to promote sales of products in the mobile shopping market. One of major product advertisements is a banner ad which inserts a banner including an image or text describing a product in a predetermined area of a user-loaded page, and moves the user to a detailed page for the product, when the user clicks on the banner. However, such banner ads lead to a lot of meaningless selections and are exposed indiscriminately to an unspecified number of customers with no interest in products, thus causing high cost.

To solve problems of the conventional advertisement method, a game chance-based product advertisement method according to an embodiment of the present disclosure provides information about an advertised product to users, along with a game chance associated with the advertised product. Thus, a user will pay more attention to information about the product in order to subscribe to the game chance. Further, the user is exposed to the product information for a longer time, and the user's attention to the product information is increased. As a result, a high advertisement effect may be achieved with low cost. From the viewpoint of the user, if the user ranks high in the free game chance, the user may get a free coupon or discount for the advertised product. Further, since a product registrant intending to promote the sales of the product may pay an advertisement fee by the advertised product or a discount coupon for the advertised product, the product registrant may reduce advertisement cost.

According to an embodiment of the present disclosure, the product registrant terminal 300 may register a product to be advertised to the service server 100. While only a single product registrant terminal 300 is shown in FIG. 1, it is obvious that a plurality of product registrant terminals 300 may register a plurality of products. The product registrant terminal 300 may transmit product information to the service server 100 in order to register the product.

According to an embodiment of the present disclosure, the user terminal 200 includes a mobile device and a personal computer (PC). The user terminal 200 may include a display capable of displaying a mobile page or a Web page provided by the service server 100. A user may participate in a game chance provided by the service server 100 and play a game, using the user terminal 200.

Meanwhile, a communication network 400 serves to connect the user terminal 200 and the product registrant terminal 300 to the service server 100. That is, the communication network 400 refers to a communication network that provides a connection path in which the user terminal 200 and the product registrant terminal 300 access the service server 100 and then transmit and receive data to and from the service server 100. That is, the communication network 400 according to an embodiment of the present disclosure may be configured irrespective of a communication type such as wired communication or wireless communication.

Hereinbelow, an action of a terminal may be described as an action of a subject using the terminal, for the convenience of description. For example, an action of the product registrant terminal 300 may be described as an action of a subject using the product registrant terminal 300, that is, a product registrant. For example, reception of product information from the product registrant may be understood as receiving the product information from the product registrant terminal 300.

Now, the present disclosure will be described, focusing on the internal structure of the service server 100.

FIG. 2 is a block diagram illustrating an internal structure of a service server according to an embodiment of the present disclosure.

Referring to FIG. 2, the service server 100 according to the embodiment of the present disclosure includes a product information acquirer 110, a game chance decider 120, an advertisement fee calculator 130, a game chance display 140, a game subscriber decider 150, a game player 160, a reward provider 170, a survey chance unit 180, and a social networking service (SNS) manager 190.

First, the product information acquirer 110 acquires product information about an advertised product from the product registrant terminal 300. The product information may be data such as text, an image, a video, or a sound related to the product that the product registrant wants to advertise. Additionally, the product information may include information specifying a time at which a product seller wants to provide a game chance, the number of game chances, the number and discount rate of products available in the game chances, a game used in the game chances, and so on.

More specifically, the product registrant may select a game optimized for the product to be advertised. Game types available to the product registrant may include a game that selects a winner randomly, a game of competing in ability such as quickness or memory, and so on, and the product registrant may select a game in consideration of a product image and product features.

In a specific example of the present disclosure, if the product registrant wants to advertise ‘gloves’, the product information acquirer 110 may acquire image data describing the gloves from the product registrant terminal 300. Additionally, the product information acquirer 110 may acquire information about a desired game starting time, a game type, a reward winner, and a reward type in relation to a game chance for the gloves from the product registrant terminal 300. For example, the product registrant may register information indicating free offer of the advertised product, gloves to a first-place winner in the game to the product information acquirer 110.

Additionally, when the product registrant registers product information, the product advertisement system of the present disclosure may provide the product registrant with additional information indicating which goods are better for selection by a customer survey function. Further, the product registrant may first upload game chances to the service server 100 and thus select a product having a high degree of participation. For example, if the product registrant has not decided what product to sell yet, the product registrant may first create game chances, and register the game chances to the product advertisement system. After observing for what products users consume their cyber points, the product registrant may acquire information about preferences for the products. As described later, since the number of cyber points that a user may use in one day to participate in a game chance is limited, the user has to carefully participate in each game chance. Therefore, a product corresponding to a game chance that users have selected relatively often means a product for which users have demonstrated high preference. Additionally, the product registrant may receive information about a product with a high user preference by a customer survey chance.

Then, the game chance decider 120 creates a game chance for the advertised product based on the product information acquired by the product information acquirer 110, and determines a game starting time, a game type, a reward winner, and a reward type for the game chance. Herein, the game chance decider 120 may generate a plurality of game chances for a single advertised product. Further, the game chance decider 120 may control the game starting time of one game chance not to coincide with the game starting time of another game chance. The game type of the game chance may have a time restriction, and games executable in the user terminal 200 may be used without restriction. The reward winner is information about up to what ranking a reward is to be offered, and the reward type is information about the type of a reward that the reward winner is to receive. In an embodiment of the present disclosure, the game chance decider 120 may determine the reward winner and the reward type to be the advertised product for a first-place winner and a discount coupon for the advertised product for a second-place winner.

With continued reference to the specific example of the present disclosure, the game chance decider 120 may create a game chance for the advertised product, gloves, set a game starting time for the game chance as 2:00 pm, set a game type as a card turnover game, set first-place, second-place, and third-place winners in the game as reward winners, and set reward types as gloves for the first-place winner, a 70% off coupon for a purchase of gloves for the second-place winner, and a 30% off coupon for a purchase of gloves for the third-place winner.

Further, according to an embodiment of the present disclosure, the game chance decider 120 may enable the product registrant to autonomously create a game chance. More specifically, although an advertiser, a seller, and a small business owner have no additional marketing means, they may create and expose a game chance autonomously in the advertisement method according to the embodiment of the present disclosure. For example, if the product registrant selects a product that the product registrant sells, enters a discount rate, selects a game, selects a time, and requests a game chance, a new game chance may be opened and users may participate in the game chance. That is, if the product registrant such as an advertisement agent or a seller directly selects an exposure time zone, a game, and a discount rate by means of the product registrant terminal 300, a game chance for the product may be exposed in an application of the present disclosure.

Subsequently, the advertisement fee calculator 130 may calculate an advertisement fee that the product registrant is to pay for the advertised product. According to an embodiment of the present disclosure, the advertisement fee calculator 130 may calculate the advertisement fee that the product registrant is to pay for the advertisement of the product as a reward offered in the game chance according to a request of the product registrant terminal 300, so that the product registrant may pay the advertisement product as promotion goods of the game chance for the advertisement of the product, instead of an advertisement fee. For example, the product registrant may pay gloves which are to be offered as a reward from a game chance, as an advertisement fee in return for the service of the present disclosure. Additionally or alternatively, the product registrant may pay a discount coupon for a purchase of gloves, which will be offered as a reward from the game chance, as an advertisement fee.

Further, the advertisement fee calculator 130 may automatically calculate an advertisement fee in consideration of an exposure time of a game chance, a game starting time, the number of participants in a previous game chance, and a purchase conversion rate of the game chance. For example, there may be a popular time zone in which users are concentrated, such as 10:00 to 12:00 am on weekends, and a high advertisement fee may be set for a game chance in this popular time zone. More specifically, once a desired time zone is selected, an advertisement fee for the time zone may be automatically calculated, and the advertisement fee of a peak time zone may be set to double the advertisement fee of a standard time zone.

For this purpose, to enable the advertisement fee calculator 130 to automatically calculate an advertisement fee when the product registrant registers product information, weights may be assigned to references including an exposure time of a game chance, a game starting time, the number of participants in a previous game chance, and a purchase conversion rate of the game chance, depending on how much the references affect the advertisement fee.

In another embodiment of the present disclosure, the advertisement fee calculator 130 calculates an advertisement charge on a time zone basis. The advertisement fee calculator 130 calculates a default price according to the average number of subscribers for the past three months, the average number of real participants, an average purchase rate, and per-business type features, a final price is set in a bid starting from the default price, and a product registrant who has entered a highest bid price becomes a successful bidder. Thus, a game chance for the successful bidder is exposed in the corresponding time zone.

Then, the game chance display 140 may provide the user terminal 200 with information about the start of a game in a game chance and information about the advertised product corresponding to the game chance. That is, the game chance display 140 may provide information about the game chance and the product information to the user terminal 200. More specifically, the game chance display 140 may generate a game chance table per time for a plurality of game chances. When a user selects one game chance in the displayed game chance table, the game chance display 140 may provide detailed information about an advertised product corresponding to the game chance. Herein, the game chance display 140 may make up a game chance table by arranging game chances in the order of earlier game starting times. According to an embodiment of the present disclosure, as product information is displayed together with information about a game chance, the advertisement effect for a product may be primarily achieved.

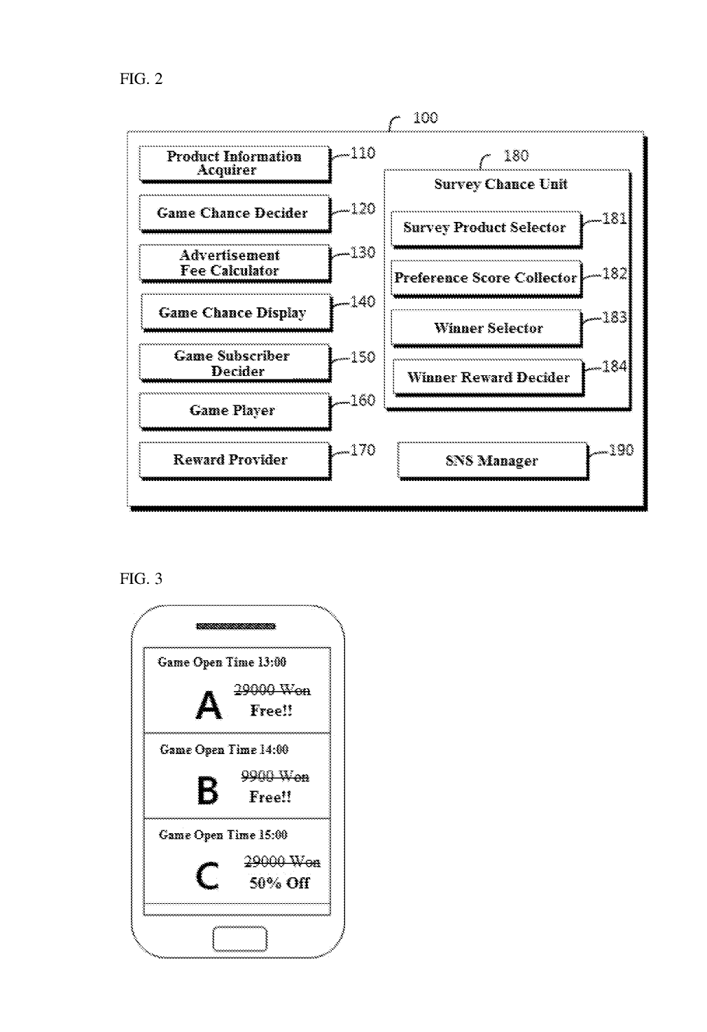

FIG. 3 is an exemplary view illustrating the user terminal 200 which displays a game chance table generated according to an embodiment of the present disclosure.

Referring to FIG. 3, a game chance table listing game chances for products A, B and C is displayed on the user terminal 200. More specifically, it may be noted that a game starts at 13:00 in a game chance for product A and a reward type is a free offer of a 29000-won product. If a user selects the game chance on the display of the terminal, a screen containing detailed information about product A may be displayed. With continued reference to the specific example of the present disclosure, product A may be gloves, and the reward type may be a free offer of gloves to a first-place winner in the game.

Additionally, according to an embodiment of the present disclosure, the game chance display 140 may display recommended game chances in consideration of tastes of the user. For example, a customized advertisement for a game chance may be automatically displayed on a personal home page of the user, or a recommended game chance may be automatically displayed according to the contents of a subscription by analyzing data about selections or subscriptions that the user has previously made.

Subsequently, the game subscriber decider 150 receives a subscription request for a game chance from the user terminal 200, and adds the user of the user terminal 200 to a subscriber list for the game chance. That is, the game subscriber decider 150 completes a subscriber list for each game chance. Herein, the game subscriber decider 150 receives subscription requests for the game chance from user terminals 200 until shortly before the starting time of the game chance, and completes a subscriber list for the game chance shortly before the starting time of the game chance. With continued reference to the specific example of the present disclosure, the game subscriber decider 150 may add a user requesting subscription to a subscriber list for the game chance for gloves.

In an embodiment of the present disclosure, only when a user requesting subscription to a game fulfills a predetermined qualification, the game subscriber decider 150 may add the user to the subscriber list. In an embodiment of the present disclosure, only when one or more detailed pages for the advertised product of the game chance are displayed on the user terminal 200, the game subscriber decider 150 may add the user to the subscriber list. That is, although it is typical that users often do not view all of the contents of an advertisement, a user needs to display all of advertisement pages to participate in a game chance according to the present disclosure. Therefore, the advertisement effect may be increased.

In an embodiment of the present disclosure, the number of game chances in which a user can participate in one day may be limited. In an embodiment of the present disclosure, a user may have three game chance subscription opportunities in one day. If the user uses up the three game chance subscription opportunities, the user may not be added to a subscriber list for any other game chance. Only a predetermined number of game chance subscription opportunities for one day may be offered to the user as cyber points. For example, if cyber points for subscription to a game chance are referred to as ‘pumpkins’, three pumpkins may be provided to a user every day. Each time the user participates in a game chance once, one pumpkin is used up. If all of the pumpkins are used up, the user is not allowed to participate in a game chance any further. This is intended to induce a user to obtain information about a product fully and then participate in a game chance, to thereby prevent indiscriminate participation in a game chance. As a consequence, the advertisement effect of a product may be increased.

In conventional advertisement methods, an advertisement is unconditionally exposed to users irrespective of preferences of the users. Therefore, an advertisement effect is low with respect to an advertisement expenditure. On the contrary, a user's selection of a game amounts to selection of an advertisement to be exposed in the advertisement method of the present disclosure. Therefore, if a user selects a game to play with limited cyber points, the effect of selecting an advertisement to be exposed by the user results. For example, since a user having three opportunities to subscribe to game chances will subscribe to game chances for products or product fields in which the user is interested by the limited subscription opportunities, the advertisement effect may be maximized. Further, if the number of opportunities to subscribe to game chances is limited as described above, a product that each user prefers may be determined. Thus, a highly preferred advertisement may be exposed in an area with a high preference per user by collecting interests of users in a customized manner.

Further, according to an embodiment of the present disclosure, the game subscriber decider 150 may transmit an alarm to user terminals 200 placed on a subscriber list a predetermined time before the starting time of a game in a game chance. That is, the game subscriber decider 150 may transmit a push message to game subscribers. Herein, if an advertisement of a product or a service is inserted in the push message, the desire for purchasing the product or service may be increased. Further, if a reward such as a coupon is offered to a user that has clicked on the push message, the advertisement message may have diversified functions.

For example, if 5 minutes are away from the starting time of the game in the game chance for gloves, the game subscriber decider 150 may notify the users listed on the subscriber list that only 5 minutes remain before the starting time of the game. Herein, the alarm transmitted by the game subscriber decider 150 may include a message asking a user whether the user will enter a game waiting room.

Further, according to an embodiment of the present disclosure, the game subscriber decider 150 may receive waiting room entry requests from users listed on the subscriber list, and admit the users to the waiting room. Information about the advertised product in the game chance may be displayed again in the game waiting room. Thus, the users view the product information once again during a game waiting time, thereby increasing the advertisement effect.

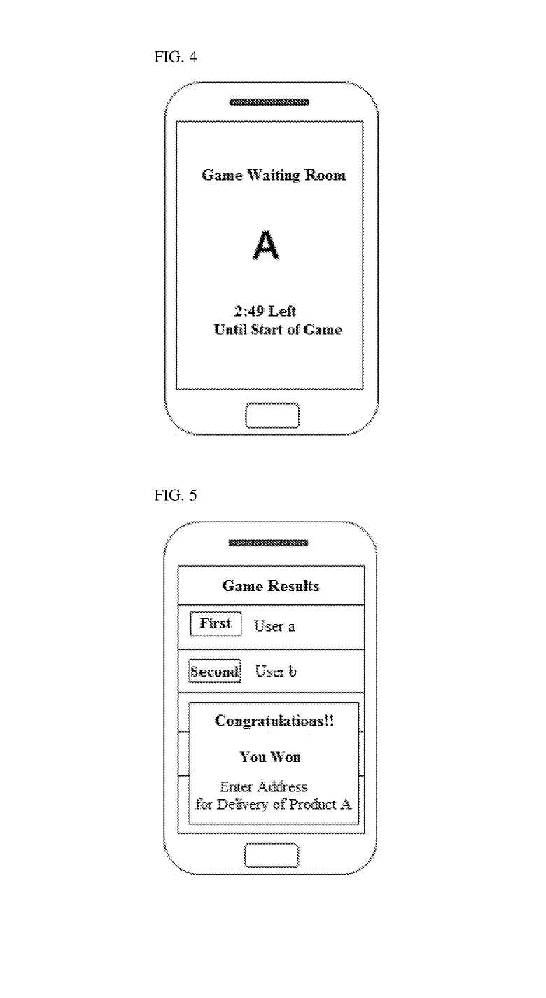

FIG. 4 is an exemplary view illustrating a game waiting room according to an embodiment of the present disclosure.

FIG. 4 is a view illustrating a screen of a game subscriber which has entered a game waiting room of a game chance. More specifically, according to an embodiment of the present disclosure, if the user selects the game chance for product A in the game chance table of FIG. 3, displays all of detailed pages describing product A, and then requests subscription to the game chance and admission to the game waiting room, such a screen as illustrated in FIG. 4 may be displayed on the user terminal 200. Herein, a time left until a game starts and advertised product information may be displayed in the game waiting room, as illustrated in FIG. 4.

Subsequently, the game player 160 provides a game to the game subscribers listed on the subscriber list for the game chance at the game starting time of the game chance. With continued reference to the specific example of the present disclosure, the same card matching game may be provided to user terminals 200 listed on the subscriber list of the game chance at the starting time of the game chance for gloves, 1:00 PM.

Only when the user terminal 200 enters the waiting room of the game chance, the game of the game chance may be played on the user terminal 200. That is, only when the user connects to the waiting room for the game chance before the start of the game, the user may participate in the game. The game may be automatically played at the predetermined starting time of the game for the users which have entered the waiting room of the game chance. Even though a user has been registered to the subscriber list, unless the user terminal 200 of the user connects to the waiting room of the game chance at the game starting time, the game of the game chance may not be provided to the user. Further, if the game starting time has elapsed, even a subscriber placed on the subscriber list may not participate in the game.

Further, the game player 160 according to an embodiment of the present disclosure may allow a user terminal which has not downloaded the application of the product advertisement system of the present disclosure to play the game. For example, if a game subscriber shows a product to another user by a mobile Web in order to share a game to which the game subscriber has subscribed, the other user may first play the game without the application, and view the result of the game chance by downloading the application.

Further, the game player 160 according to an embodiment of the present disclosure may provide product information on a game screen while the user is playing the game. That is, when the user selects the game, the product information may be primarily exposed, and when the game is played, the product information may be secondarily exposed. Therefore, the advertisement effect may be achieved.

Then, the reward provider 170 determines rankings in the game by collecting the play results of the game, and determines a reward recipient and a reward type for the game chance based on the rankings. The rankings may be rankings of scores that the game players have achieved in the game, or rankings of players which have finished the game earlier. As described before, the game chance decider 120 may determine a reward winner and a reward type for the game chance. The reward provider 170 may determine a user of a determined ranking in the game to be the reward winner and determine to offer a reward to the user.

With continued reference to the specific example of the present disclosure, the reward winner and reward type for the game chance of gloves may be a free offer of gloves to a first-place winner, an offer of a 70% off coupon for a purchase of gloves to a second-place winner, and an offer of a 50% off coupon for a purchase of gloves to a third-place winner. The reward provider 170 may select the first-place winner, the second-place winner, and the third-place winner as reward recipients, and transmit information about the reward types to the reward winners.

Further, in a selective embodiment of the present disclosure, the reward provider 170 may offer a reward only when a reward recipient uses the reward immediately, simultaneously with reception of reward information. That is, the reward provider 170 may prompt the reward recipient to use the reward immediately, while notifying the reward recipient of the reward. If the reward winner does not use the reward immediately, the reward may be cancelled. This is intended to increase a product purchase probability as well as to fast notify a reward offer.

Further, according to an embodiment of the present disclosure, the reward provider 170 may determine a reward winner in a different manner according to a game. With continued reference to the specific example of the present disclosure, the reward provider 170 may randomly select 10 users from among top 100 players of a game, and determines the selected 10 users as reward recipients. In another example, the reward provider 170 may select players ranked in the first, tenth, and 100^{th} places, and determine the selected players as reward recipients. In a further example, the reward provider 170 may select players randomly from among total players of the game irrespective of their scores, and determine the selected players as reward recipients.

Further, according to an embodiment of the present disclosure, the reward provider 170 may provide product information along with information about a reward to a user. That is, when the user selects a game, product information is primarily exposed, when the user plays the game, the product information is secondarily exposed, and when a reward is offered to the user, the product information is finally provided. Thus, the advertisement effect may be achieved.

Further, in the specific example of the present disclosure, at the same time when the first-place winner of the game is notified of a reward, the first-place winner may be prompted to enter an address to which the reward, that is, free gloves are to be delivered. At the same time when the second-place winner of the game is notified of a reward, the second-place winner may be prompted to purchase gloves with a 70% off coupon. If the first-place winner or the second-place winner does not use the reward immediately, the reward may be cancelled. That is, the present disclosure may offer different rewards regarding purchase of goods or services according to the game scores of users which have participated in a game chance. The different rewards may be provided in a time-sale manner so that upon timeout of a predetermined time, the reward may be expired. Further, a discount coupon may be provided as a reward to every participant in a game chance. That is, the advertisement system according to an embodiment of the present disclosure may offer a discount coupon treated like cash as a reward to a user which has viewed and participated in or subscribed to a game, instead of offering points to a user which just views an advertisement. As a consequence, the advertisement effect may be increased.

FIG. 5 is an exemplary view illustrating the user terminal 200 displaying game results according to an embodiment of the present disclosure.

In FIG. 5, a screen displayable on the user terminal 200 of a first-place winner in a game, user a is shown, by way of example. Referring to FIG. 5, the reward provider 170 may display a screen announcing the results of the game. Further, if the first-place winner of the game is a reward winner, the reward provider 170 may determine user a winning in the first place in the game as a reward recipient and receive an address to which product A being a reward type will be delivered for free. As described before, according to an embodiment of the present disclosure, if a reward is not used upon announcement of the reward, the reward may be cancelled.

Additionally, the advertisement system according to an embodiment of the present disclosure may provide a function of communication between users regarding a game chance. For example, users may share information about a product or a game chance by managing a home page using an SNS function, opening a chatting window, or writing a reply on a product page in the product advertisement system of the present disclosure. Since users selecting the same game chance are highly likely to have common interest, the users are allowed to talk with each other by the SNS function, to thereby exchange information about goods or a service. Further, a user achieving a high score in the above-described style chance may be allowed to create content about the product or the game chance on his or her own.

Referring to FIG. 2 again, the survey chance unit 180 includes a survey product selector 181, a preference score collector 182, a winner selector 183, and a winner reward decider 184. The survey chance unit 180 is a component for providing a survey chance service of the present disclosure. The survey chance service is a service of conducting a survey of users' preferences for a product and offering a reward to a survey winner that has entered a preference closest to the average preference of the product.

More specifically, the survey product selector 181 selects a product selected by a product registrant as a survey product. The product registrant may be an advertiser, and one or more products may be selected as survey products in each category (e.g., clothes, home appliances, offline tickets, and so on). The survey product selector 181 selects, arranges, and provides one or more survey products per product category. The survey products may be arranged based on current preference scores of the survey products.

According to another embodiment of the present disclosure, the survey product selector 181 may select a product selected based on a user request as a survey product. For example, if three or more product purchasers request registration of a specific product as a survey product, the survey product selector 181 may select the product as a survey product without receiving a request from a product registrant.

Additionally or alternatively, the survey product selector 181 may select survey products so that products selected by a product registrant and products selected by users may become survey products at a predetermined ratio. For example, the survey product selector 181 may select one half of survey products from products selected by a product registrant and the other half of the survey products from products selected by users.

Then, the preference score collector 182 collects preference scores for a survey product from a plurality of survey participants among users. That is, users may enter their preference scores for the survey product in a survey created for the survey product, and the preference score collector 182 collects the preference scores of the plurality of survey participants.

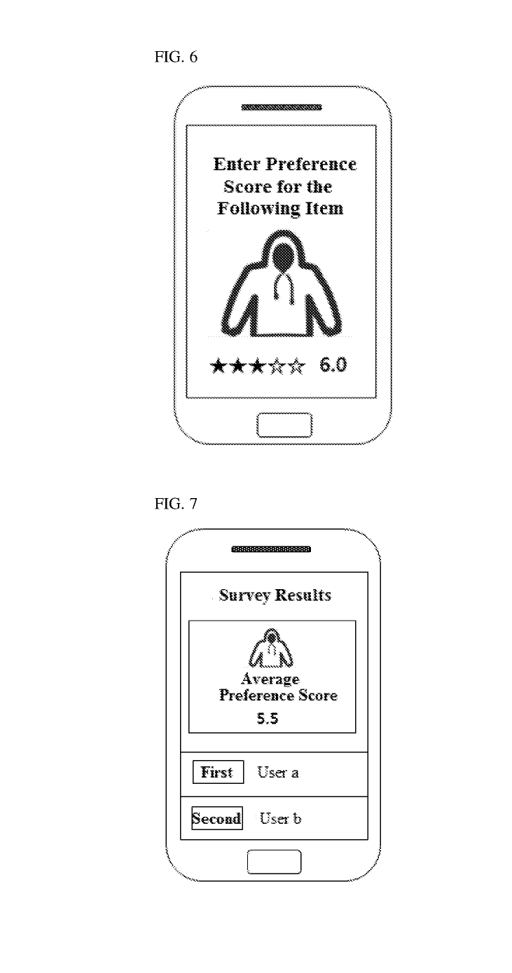

FIG. 6 is an exemplary view illustrating a user terminal which displays a screen for collecting preference scores according to an embodiment of the present disclosure.

Referring to FIG. 6, a message prompting a user to enter a preference score for a specific item may be displayed, and the user may enter or select his or her preference score for the item. In the embodiment of FIG. 6, it is noted that the user has entered a preference score of 6.0 for the item. In this method, the preference score collector 182 collects preference scores entered by users.

Further, the preference score collector 182 according to an embodiment of the present disclosure may arrange the collected preference scores by gender, age, and purchase history, and provide the arranged preference scores. Further, the preference score collector 182 according to an embodiment of the present disclosure may provide a product registrant of a notification recommending registration of a game chance of the present disclosure for a highly preferred survey product.

Herein, the preference score collector 182 may collect only the preference scores of users having cyber points. That is, only users having cyber points may enter preference scores in a survey chance, and a predetermined number of cyber points for one day or cyber points corresponding to a predetermined money amount for one day may be given to the users. For example, only cyber points with which to participate in five survey chances per day may be provided to users.

Subsequently, the winner selector 183 calculates the average of the collected preference scores, and selects one or more winners based on the average. Herein a winner may be a user which has entered a preference score closest to the average preference score. One or more winners may be selected according to a setting. For example, if the average of preference scores entered by a plurality of users is 5.5, user a has entered 5.3, and user b has entered 5.6, user a may be a winner. Meanwhile, if one winner is set and the deviations of the preference scores entered by two or more users from the average of the preference scores are equal, like the case where user a has entered 5.3 and user has entered 5.7, user b which has entered the higher preference score may be selected as the winner. Further, if a survey is conducted for a plurality of successive survey products, a user which has entered a preference score closest to the average of preference scores for the first survey product may be selected as a winner.

FIG. 7 is an exemplary view illustrating a user terminal which displays survey results according to an embodiment of the present disclosure.

Referring to FIG. 7, the results of a survey are displayed on a user terminal. In the embodiment of FIG. 7, it may be noted that the average of preference scores collected for the specific product in the embodiment of FIG. 6 is 5.5. Further, users are ranked based on the average preference score, and as noted from FIG. 7, user a and user b are ranked sequentially in the first and second places in the order of closeness to the average preference score. Therefore, the winner selector 183 may select user a as the winner of the survey chance for the corresponding product. In an embodiment of the present disclosure, the winner of the survey chance may be referred to as a ‘stylist’.

Then, the reward decider 184 may determine a reward to be granted to the winner. According to an embodiment of the present disclosure, a user having a preference score closest to the average of the preference scores of users for a survey product may be rewarded. For example, a free coupon or a discount coupon for the survey product may be provided to the winner. The product registrant (advertiser) may use the style survey service of the present disclosure by supporting a free coupon or a discount coupon to be provided to the survey winner. Additionally or alternatively, besides the winner, the reward provider 184 may provide a discount reward to a predetermined number of users in the order of closeness to the average preference score.

According to an embodiment of the present disclosure, the reward decider 184 may limit a reward validity time. For example, the reward decider 184 may provide a discount coupon valid only during 24 hours to the winner after the survey ends, and notify the winner of cancellation of the reward after the limited time.

With continued reference to FIG. 2, the SNS manager 190 may provide an SNS account to each user. The user may register his or her interested product through the SNS account provided to the user, and share information with other users.

More specifically, the SNS manager 190 according to an embodiment of the present disclosure may register other users which have participated as SNS acquaintances of users in the same game chance or survey chance. Thus, a group of users having similar interests formed through a game chance or survey chance, or participants in the game change or survey chance may advantageously engage in their own social activities.

Further, the SNS manager 190 according to an embodiment of the present disclosure may automatically register participants in a survey chance as followers of a survey winner. Additionally or alternatively, the SNS manager 190 according to an embodiment of the present disclosure may register participants in a game chance as followers of a winner of the game chance.

Further, the SNS manager 190 according to an embodiment of the present disclosure may derive interests of users based on limited cyber points of the users, referring to game chances or survey chances selected by the users, and recommend SNS acquaintances based on the derived interests. As described before, users may participate in a game chance or survey chance, using a limited number of cyber points. For example, even though 30 game chances are created per day, if cyber points available only for five game chances are given to each user, game chances selected by the user may be considered as reflecting interests of the user. Therefore, the SNS manager 190 according to an embodiment of the present disclosure may determine interests of a user based on game chances or survey chances selected by the user, and establish an SNS acquaintance relationship between users having the same interests.

Further, the SNS manager 190 according to an embodiment of the present disclosure may provide a platform on which a user may autonomously create a game chance own and register the game chance to the user's SNS page. That is, according to an embodiment of the present disclosure, a product or service seller may create a game chance directly. Herein, an SNS page of a user may refer to a home page corresponding to a user account, or a Web page of a personal account such as Facebook, Instagram, or a blog. More specifically, a user may create a game chance by primarily selecting a product or service to be advertised, secondarily selecting a game type, and then determining a reward and selecting a method for rewarding a game participant (e.g., whether to reward only a first-place winner or a randomly selected one of game participants). Further, the SNS manager 190 according to an embodiment of the present disclosure may set a specific amount of money for a voucher for creating a game chance.

For example, the user may purchase a voucher for creating 10 game chances for 30,000 won for one month. As described before, the user which has purchased the voucher may post a game chance generated by setting product information, a reward, a game type, and the number of game participants on the user's SNS page. Other users may get a discount coupon after selecting the game chance posted on the SNS page of the user and playing a game. Therefore, the product seller may achieve a high advertisement effect with respect to marketing cost.

Further, the SNS manager 190 according to an embodiment of the present disclosure may enable the user which has created the game chance to invite the user's acquaintances to a game room for the game chance. Herein, the SNS manager 190 may impose a condition that an admission fee is to be paid to enter the game room, according to an input of the user. In this case, the admission profit may be used to reward a winner in the game room, for example, as cost to be expended to offer an advertised product.

Further, the SNS manager 190 according to an embodiment of the present disclosure may post information about a survey product on an SNS page of a user selected as a survey winner. For example, the SNS manager 190 may post information about the survey product in the survey and information indicating that the user has been selected as the winner of the survey on the home page of the user selected as the survey winner. Further, the information about the survey product posted by the SNS manager 190 may include a link to a shopping site in which the product is available. If the survey product is purchased via the link, the SNS manager 190 may determine to allocate a part of the profit to the user corresponding to the home page account.

Additionally, the SNS manager 190 provides an SNS platform on which the user selected as the survey winner may provide mobile broadcasting as a shopping host for the survey product. Thus, while advertisement traffic is secured for the survey product, the survey winner may engage in creative activities and make profit, and other users may easily determine whether to purchase the survey product and enjoy convenient shopping, referring to product contents created and posted on the home page by the survey winner.

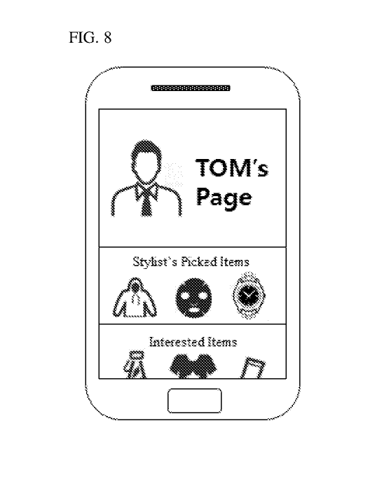

FIG. 8 is an exemplary view of an SNS page of a user according to an embodiment of the present disclosure.

Referring to FIG. 8, an SNS page of a user called TOM is shown. As described before, according to an embodiment of the present disclosure, product information in a survey chance in which a user has been selected as a survey winner may be displayed on an SNS page of the user. In the embodiment of FIG. 8, the survey winner may be referred to as a ‘stylist’, and a list of survey products for which the user has been selected as a survey winner and information about the survey products (pictures of the products in the embodiment of FIG. 8) may be displayed under ‘stylist's picked items’. When a user selects product information displayed under the stylist's picked items, the user may move to a shopping site selling a corresponding product. That is, according to the embodiment of FIG. 8, the user TOM has been selected as a survey winner in survey chances for the items displayed under the ‘stylist's picked items’, and other users may select a link to a displayed item and move to a shopping site selling the item. Thus, other users may be aware that the user TOM is a user having preferences closest to the preferences of the displayed survey products. Further, other users may move to a shopping site in which a product is purchasable by selecting a link to the survey product. Herein, if another user purchases a survey product by selecting a link, a predetermined ratio of the purchase amount may be paid to the user of the page (the user TOM in the embodiment of FIG. 8).

As is apparent from the foregoing description, according to the present disclosure, as a survey for collecting preference scores for a product is created, a meaningful evaluation of users may be provided to a product registrant.

According to the present disclosure, since a reward is offered to a survey winner which has entered a preference score closest to an average preference score for a product, users are motivated to enter preferences.

According to the present disclosure, the reliability of a survey winner regarding product evaluation may be increased by providing information about a survey product on an SNS page of the survey winner.

The foregoing embodiments of the present disclosure are purely exemplary, not limiting the scope of the present disclosure. For the simplicity of the disclosure, conventional electronic structures, control systems, software, and other functional blocks of the systems may not be disclosed. Further, connections or connection members between components illustrated in the drawings are exemplary functional connections and/or physical or circuit connections. In a real device, the connections may be replaced, or represented as various additional functional connections, physical connections, or circuit connections. Unless mentioned specifically like “mandatory” or “important”, a component may not always be needed for application of the present disclosure.

In the present disclosure (particularly, the appended claims), the term “the” or its similar term may correspond to both singular and plural expressions. If a range is described in the present disclosure, a disclosure to which an individual value within the range is applied is included (unless otherwise specified), which is equivalent to description of each individual value of the range in the detailed description of the disclosure. Finally, unless clearly specified or otherwise specified, the order of steps in a method of the present disclosure may be changed appropriately, not limiting the present disclosure. Every example or exemplary term (for example, etc.) is given just to describe the present disclosure in detail. Unless limited by the claims, the examples or exemplary terms do not limit the scope of the present disclosure. Further, those skilled in the art will understand that the present disclosure can be implemented according to a design condition and factor within the claims or their equivalents to which various modifications, variations, and combinations are made.

The above-described embodiments of the present disclosure may be implemented as program commands that are executed through various computer components and written on a computer-readable recoding medium. The computer-readable recording medium may include a program command, a data file, and a data structure alone or in combination. The program commands written to the computer-readable recoding medium may be specially designed and configured for the present disclosure or known and available to those skilled in the field of computer software. Examples of the computer-readable recoding medium include a magnetic medium such as a hard disk, a floppy disk, and a magnetic tape, an optical recoding medium such as a compact disk-read only memory (CD-ROM) and a digital versatile disk (DVD), a magneto-optical medium such as a floptical disk, and a hardware device specially configured to store and execute a program command, such as a ROM, a RAM< and a flash memory. The program commands include, for example, a premium language code that can be executed by a computer using an interpreter as well as a machine language code. A hardware device may be changed to one or more software modules for processing according to the present disclosure, or vice versa.

What is claimed is:

1. A system for providing shopping information, comprising:
a survey product selector for selecting a product selected by a product registrant as a survey product;
a preference score collector for collecting preference scores for the survey product from a plurality of survey participants among users;
a winner selector for calculating the average of the preference scores, and selecting at least one survey winner from among the plurality of survey participants based on the average; and
a winner reward decider for determining a reward to be offered to the at least one survey winner.

2. The system of claim 1, wherein the winner selector determines rankings of the plurality of survey participants in an order of closeness of entered preference scores to the average.

3. The system of claim 1, wherein the preference score collector collects preference scores from users having cyber points, and cyber points corresponding to a predetermined money amount are paid to each of the plurality of users during a predetermined time period.

4. The system of claim 1, wherein the reward decider determines a free coupon for free offer of the survey product as the reward.

5. The system of claim 1, further comprising a social networking service (SNS) manager for providing an SNS account to each of the users,
wherein the SNS manager displays information about the survey product on an SNS page of a user selected as the survey winner.

6. The system of claim 5, wherein upon occurrence of a purchase of the survey product through a link corresponding to the information about the survey product displayed on the SNS page, the reward decider determines to allocate a part of a purchase profit to the survey winner.

7. A method for providing shopping information, comprising:
a survey product selection step for selecting a product selected by a product registrant as a survey product;
a preference score collection step for collecting preference scores for the survey product from a plurality of survey participants among users;
a winner selection step for calculating the average of the preference scores, and selecting at least one survey winner from among the plurality of survey participants based on the average; and
a winner reward determination step for determining a reward to be offered to the at least one survey winner.

8. The method of claim 7, wherein the winner selection step comprises determining rankings of the plurality of survey participants in an order of closeness of entered preference scores to the average.

9. The method of claim 7, wherein the preference score collection step comprises collecting preference scores from users having cyber points, and
wherein cyber points corresponding to a predetermined money amount are paid to each of the plurality of users during a predetermined time period.

10. The method of claim 7, wherein the winner reward determination step comprises determining a free coupon for free offer of the survey product as the reward.

11. The method of claim 7, further comprising a social networking service (SNS) management step for providing an SNS account to each of the users,
wherein the SNS management step comprises displaying information about the survey product on an SNS page of a user selected as the survey winner.

12. The method of claim 11, wherein the winner reward determination step comprises, upon occurrence of a purchase of the survey product through a link corresponding to the information about the survey product displayed on the SNS page, determining to allocate a part of a purchase profit to the survey winner.
